(19) United States
(12) Patent Application Publication
(10) Pub. No.: US 2025/0288903 A1
(43) Pub. Date: Sep. 18, 2025

(54) METHOD AND SYSTEM FOR ADAPTIVE MOTION SIMULATION IN GAMING

(71) Applicant: D-BOX TECHNOLOGIES INC., Longueuil (CA)

(72) Inventor: Jean-François MENARD, Longueuil (CA)

(21) Appl. No.: 18/860,197

(22) PCT Filed: May 9, 2023
(86) PCT No.: PCT/CA2023/050628

§ 371 Date: Oct. 25, 2024

Related U.S. Application Data
(60) Provisional application No. 63/339,657, filed on May 9, 2022.

(51) Int. Cl. A63F 13/285

(52) U.S. Cl. CPC A63F 13/285

(57) ABSTRACT

A system for generating motion simulation in gaming may include a haptic engine including a processing unit and a non-transitory computer-readable medium having stored thereon computer instructions which, when executed by the processing unit, cause the processing unit to implement: receiving an input from a game controller, the input from the game controller configured to cause an action in a video game; in response to a receipt of the input, retrieving at least one motion code associated with the input in a database, the motion code being representative of a haptic effect to be performed by a motion platform; and obtaining a motion signal corresponding to the at least one motion code and outputting the motion signal to the motion platform for the haptic effect to be performed at the motion platform in synchronicity with the action occurring in the video game.

### CROSS-REFERENCE TO RELATED APPLICATION

The present application claims the priority of U.S. Patent Application No. 63/339,657, filed on May 9, 2022 and incorporated herein in its entirety by reference.

### TECHNICAL FIELD

The present disclosure relates generally to motion platforms, and more specifically to generating motion simulation in synchronization with video games.

### BACKGROUND OF THE ART

Motion simulators performing vibro-kinetic effects are commonly used to enhance a viewing experience of a video program. In such technology, a motion simulator features a seat, chair or platform that is displaced by one or more actuators in vibro-kinetic effects in synchronization with an audio-visual program or visual event. In a particular type of such motion simulators, the motion simulators move based on motion signals that are encoded as a motion track, in contrast to vibrations being extracted from a soundtrack of an audio-visual program.

Currently, motion track production is largely the work of professionals, done in post-production. For instance, companies that commercialize motion platforms employ professional motion track designers who produce a limited number of motion tracks, based on the resources of the company and using specialized tools, on existing media content. As a result, motion tracks are often not available for all media content, including video games. In video games, the video and audio outputs occur live as a real-time response to user inputs on a game controller, and the storyline develops and evolves live.

It would be desirable to provide tools for motion track generation which could be used in the gaming industry.

### SUMMARY

In accordance with a broad aspect, there is provided a system for generating motion simulation in gaming comprising: a haptic engine including a processing unit and a non-transitory computer-readable medium having stored thereon computer instructions which, when executed by the processing unit, cause the processing unit to implement: receiving an input from a game controller, the input from the game controller configured to cause an action in a video game; in response to a receipt of the input, retrieving at least one motion code associated with the input in a database, the motion code being representative of a haptic effect to be performed by a motion platform; and obtaining a motion signal corresponding to the at least one motion code and outputting the motion signal to the motion platform for the haptic effect to be performed at the motion platform in synchronicity with the action occurring in the video game.

Further in accordance with the broad aspect, for instance, the system may be used for receiving a user input indicative of at least one haptic effect to be paired with a given input from the game controller, and storing at least one motion code corresponding to the received haptic effect in the database for the retrieving.

Still further in accordance with the broad aspect, for instance, the system may be used for receiving a user input indicative of at least one parameter of the haptic effect to be paired with the given input, and storing the at least one parameter in the database for the retrieving.

Still further in accordance with the broad aspect, for instance, receiving the user input includes receiving two or more of the haptic effects to be paired with a single one of the given input from the game controller in the pairing, and storing two or more of the at least one motion code corresponding to the received haptic effects in the database for the retrieving.

Still further in accordance with the broad aspect, for instance, obtaining the motion signal includes mixing the two or more of the at least one motion code associated with the single one of the given input.

Still further in accordance with the broad aspect, for instance, wherein the storing is under a user profile.

Still further in accordance with the broad aspect, for instance, the storing includes storing a plurality of the motion codes in the database, each in association with a respective given input.

Still further in accordance with the broad aspect, for instance, the system may be used for operating a graphical user interface receiving the user inputs indicative of the at least one haptic effect.

Still further in accordance with the broad aspect, for instance, the system may include a motion platform for performing the haptic effect in synchronicity with the action occurring in the video game.

Still further in accordance with the broad aspect, for instance, obtaining the motion signal includes synthesizing the motion signal from instructions corresponding to the motion code.

Still further in accordance with the broad aspect, for instance, synthesizing the motion signal includes producing a waveform corresponding to the haptic effect.

Still further in accordance with the broad aspect, for instance, synthesizing the motion signal includes providing an amplitude and frequency of the waveform.

Still further in accordance with the broad aspect, for instance, the system may be used for capturing video and/or audio data from the video game, and processing the video and/or audio data; and obtaining a motion signal as a function of the processing, and outputting the motion signal to the motion platform for a haptic effect to be performed at the motion platform in response to the processing.

Still further in accordance with the broad aspect, for instance, obtaining the motion signal as a function of the processing includes mixing the motion signal of the processing with the motion signal corresponding to the response to the receipt of the input.

Still further in accordance with the broad aspect, for instance, the at least one motion code includes an array of motion samples with a sample rate.

Still further in accordance with the broad aspect, for instance, retrieving the at least one motion code associated with the input in the database includes identifying the input as a group selector entry.

Still further in accordance with the broad aspect, for instance, identifying the input as the group selector entry includes disabling a current motion code associated with the input, and enabling a subsequent motion code associated with the input.

Still further in accordance with the broad aspect, for instance, generating the motion signal includes obtaining the motion signal corresponding to the subsequent motion code.

Still further in accordance with the broad aspect, for instance, the current motion code is a default motion code.

Still further in accordance with the broad aspect, for instance, the system may be used for storing the subsequent motion code as current motion code.

In accordance with another broad aspect, there is provided a method for generating motion simulation in gaming comprising: receiving an input from a game controller, the input from the game controller configured to cause an action in a video game; in response to a receipt of the input, retrieving a motion sample associated with the input in a database, the motion sample being representative of a haptic effect to be performed by a motion platform; and outputting the retrieved motion sample to the motion platform for the haptic effect to be performed at the motion platform in synchronicity with the action occurring in the video game.

Features of the systems, devices, and methods described herein may be used in various combinations, and may also be used for the system and computer-readable storage medium in various combinations.

### BRIEF DESCRIPTION OF THE DRAWINGS

Further features and advantages of embodiments described herein may become apparent from the following detailed description, taken in combination with the appended drawings, in which:

FIG. 1 is a schematic view of a system for generating adaptive motion simulation in gaming, in accordance with a variant of the present disclosure;

FIG. 2 is a face view of an exemplary game controller used in generating adaptive motion simulation in gaming;

FIG. 3 is a block diagram showing a haptic engine for generating adaptive motion simulation in gaming, in accordance with a variant of the present disclosure;

FIG. 4 is a schematic view showing motion code mixing in accordance with a variant of the present disclosure; and

FIG. 5 is an exemplary graphic user interface (GUI) used in generating adaptive motion simulation in gaming.

It will be noted that throughout the appended drawings, like features are identified by like reference numerals.

### DETAILED DESCRIPTION

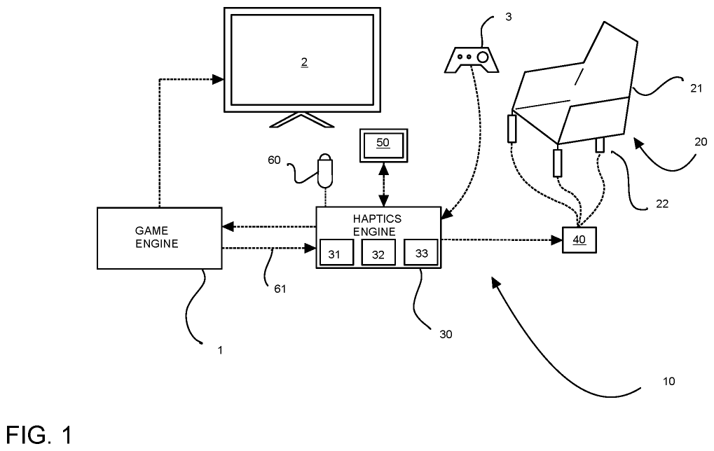

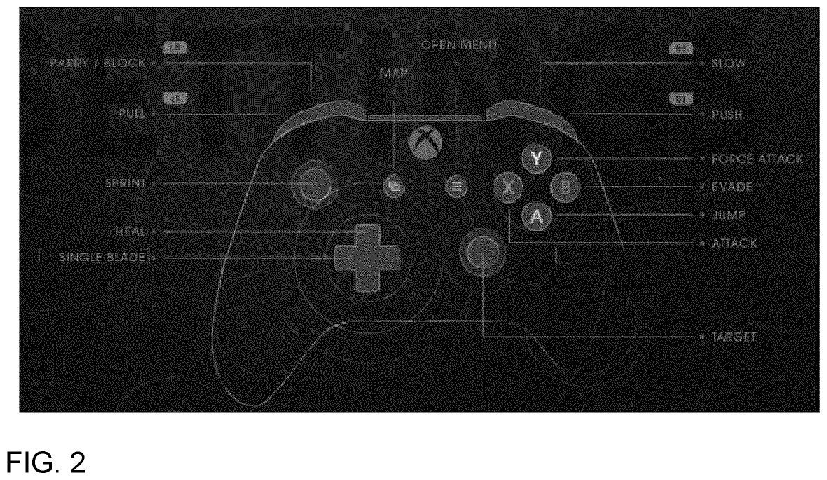

Referring to the drawings, and more particularly to FIG. 1, there is illustrated a typical gaming setup, with a game engine 1, a monitor 2, and a game controller 3. In the context of the present application, a game may be any application or software where there is audio or visual interaction, such as 2D display, 3D display, virtual reality (VR), augmented reality (AR), or combinations thereof. The setup is shown in a basic arrangement, and can have multiple other components, such as an audio system, a gaming chair, etc. The game engine 1 may be in a personal computer (PC), in a laptop, in a portable device or in a gaming console, and includes all necessary hardware and software components to operate a video game. The monitor 2 is one example of the displaying devices that can be used to display graphics associated with a video game, and may be a television, a computer screen, a VR helmet, a portable device, or any combination thereof, or multiple of any such device, such as multiple monitors 2. The game controller 3, also known as a gaming controller, a controller, may be of any particular type, such as the exemplary one shown in FIG. 2, and is an input device to provide input to a game operated by the game engine 1. The game controller 3 may also be a keyboard, a mouse, a joystick, a portable device (e.g., smart phone, tablet), or any combination thereof. The game controller(s) 3 may be wired or wireless.

Still referring to FIG. 1, there is illustrated at 10 a system for generating adaptive motion simulation in gaming, in accordance with a variant of the present disclosure. The system 10 is shown as being used in conjunction with the gaming setup featuring the game engine 1, the monitor 2, and the game controller 3, among other components. For simplicity, the system for generating adaptive motion simulation in gaming is referred to herein as the system 10.

The system 10 may include a motion platform 20, a haptic engine 30, an actuator interface 40, a user interface 50 and/or a capture device 60, though some of these components may be absent.

The motion platform 20 is tasked with outputting haptic effects for instance in the form of vibro-kinetic effects, in synchronization with a video output and/or an audio output and/or a live event. By way of example, the motion platform 20 may include a motion simulator, a vibro-tactile device (such as in the user interface 50), inertial shakers, etc. The motion simulator is of the type that receives actuation signals so as to move an output thereof in accordance with a set of movements. The actuation signals may be known as motion signals that are representative of movements to be performed being received from a controller, and may be as a function of motion code.

In the illustrated embodiment, the motion simulator has a seat having a seat portion 21 in which a user(s) may be seated. For example, the seat portion 21 is part of a gaming chair. Other occupant supporting structures may be included, such as a platform, but for simplicity the expression seat portion 21 will be used in the present application. The seat portion 21 is shown as having armrests, a seat, and a backrest and this is one of numerous configurations considered, as the seat portion 21 could be for a single user, multiple users, may be a bench, etc. The motion simulator may also have an actuation system by which the output, namely the seat portion 21, is supported to the ground. The actuation system is shown as having linear actuators 22 is partly visible. The actuation system may have one or more of these linear actuators 22, supporting the output, i.e., the seat portion 21, from the ground. The seat portion 21 is shown as having three of these linear actuators 22, but a single linear actuator 22 may be present. The seat portion 21 may also be supported by a seat leg, column or post with passive joint(s) in parallel arrangement with the linear actuator(s) 22.

In an embodiment, the linear actuator 22 is an electro-mechanical actuator of the type having a ball-screw system, although other types of linear actuators may be used. For example, a single one of the linear actuators 22 can produce up and down motion and vibrations. A pair of the linear actuators 22 can produce two of up and down motion, pitch motion or roll motion, with or without a passive joint. Three linear actuators 22 can produce up and down motion, pitch motion and roll motion. The motion platform 20 of FIG. 1 is one among numerous possible configurations for the motion simulator. For example, the motion simulator may support a platform or structure instead of a seat portion.

For context, vibro-kinetic effects refers to vibrations and/or displacements performed by a motion platform and presented to a user as a sensory feedback. By way of non-limiting example, the vibro-kinetic effects may be low amplitude reciprocate movements or vibrations, from 1 micron to 200 mm, it may have a low frequency spectral content, such as 0-5 Hz, 20-100 Hz or 0-200 Hz, and may contain one or more dimension or channel. According to an embodiment, the vibro-kinetic effects are encoded effects, also known or embodied as motion samples, motion code or haptic effect modules. In a variant, the motion code is a digital file containing executable instructions to cause a haptic effect.

In addition to the example of FIG. 1, a motion platform can take various forms, such as a vibro-kinetic platform for lifting people relative to a structure, a motion platform supporting a seat, a chair with inertial shakers, a portable tactile display for providing haptic feedback, wearable actuators embedded in a vest, etc. Actuators can be of various types, such as linear, rotary, voice coil, resonant, inertial, and the like, and be powered from various source, such as electric (including electromechanical), pneumatic, hydraulic, etc.

The haptic engine 30 may also be known as a motion controller, or as a component thereof, the motion controller including software and/or hardware to execute the different tasks. The haptic engine 30 feeds the motion platform 20 with a motion signal representative of the vibro-kinetic effects to be performed by the motion platform 20. The motion signal is output as a result of actions occurring in the game, and includes actuator-driving instructions to drive the actuators 22 of the motion platform 20 to perform the programmed vibro-kinetic effects in audio-visual output. Other names for the motion signal may include vibro-kinetic signal, motion code, motion samples, data packets of motion, etc. The motion platform 20 may therefore have a digital signal processor and/or driver in order to convert the motion signal received from the haptic engine 30 into signals controlling the movements performed by the actuators to displace the seat or platform of the motion platform 20.

It should be noted that although the present disclosure focuses primarily on the seat-shaped motion platform 20, other types of motion platforms, including harnesses, planks, and the like, are also considered. In order to control the movement of the motion platform 20, the haptic engine 30 interprets sets of instructions which cause the haptic engine 30 to induce movements in the motion platform 20 in accordance with the video and/or audio game.

The haptic engine 30 is a computing device that may include a processing unit 31 and a memory 32 which has stored therein computer-executable instructions 33. The processing unit 31 may include any suitable devices configured to cause a series of steps to be performed so as to implement a method for generating adaptive motion simulation in gaming such that instructions 33, when executed by the haptic engine 30 or other programmable apparatus, may cause the functions/acts/steps specified in the methods described herein to be executed. The processing unit 31 may be, for example, any type of general-purpose microprocessor or microcontroller, a digital signal processing (DSP) processor, a central processing unit (CPU), an integrated circuit, a field programmable gate array (FPGA), a reconfigurable processor, other suitably programmed or programmable logic circuits, or any combination thereof. In a variant, the computing device of the haptic engine may be the same as the processing unit of the game engine 1, such as the processing unit of personal computer, laptop or game console operating the video game. The haptic engine 30 may be computer-executable instructions in such PC, laptop, game console, etc.

The memory 32 may comprise any suitable known or other machine-readable storage medium. The memory 32 may include non-transitory computer readable storage medium, for example, but not limited to, an electronic, magnetic, optical, electromagnetic, infrared, or semiconductor system, apparatus, or device, or any suitable combination of the foregoing. The memory 32 may include a suitable combination of any type of computer memory that is located either internally or externally to the haptic engine 30, for example random-access memory (RAM), read-only memory (ROM), compact disc read-only memory (CDROM), electro-optical memory, magneto-optical memory, erasable programmable read-only memory (EPROM), and electrically-erasable programmable read-only memory (EEPROM), Ferroelectric RAM (FRAM) or the like. Memory 32 may be any storage means (e.g., devices) suitable for retrievably storing machine-readable instructions 33 executable by processing unit 31.

The actuator interface 40 may include the necessary electronics to receive a digital signal with motion content, for instance from the haptic engine 30, to drive the actuation system, e.g., the actuator(s) 22 in performing movements in synchronization with an audio or video output of the game, as described hereinafter. The actuator interface 40 is shown as a standalone device, but may be integrated into the haptic engine 30. The actuator interface 40 may also be tasked with converting the digital signal with motion content into adapted driving signals as a function of the nature of the motion platform 20. For example, the actuator interface 40 may create actuator-specific driving signals as a function of the nature of the actuator(s) 22, the number of actuators, and their location. The actuator interface 40 will therefore provide a suitable signal for the actuator 22 if it is a left-side actuator, in a setup comprising a pair of the actuators 22, or if the actuator 22 is an inertial shaker, etc.

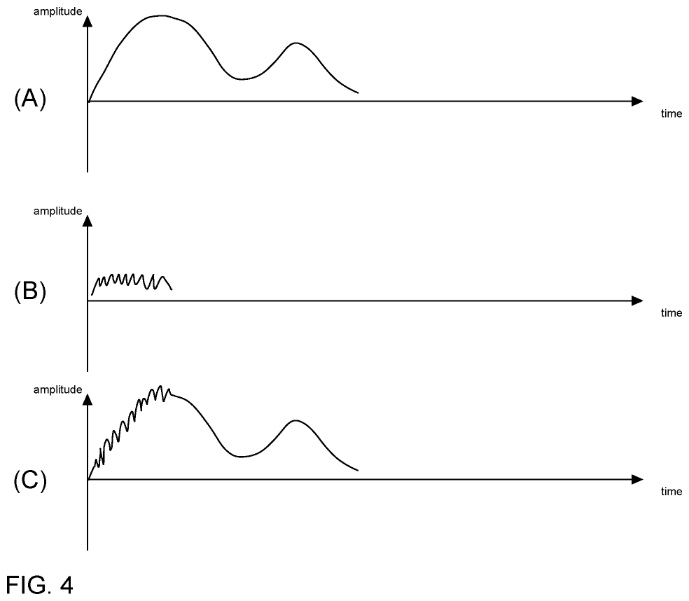

The user interface 50 is shown as being a portable device in FIG. 1, such as a tablet. However, the user interface 50 may take other forms. For example, the user interface 50 may be embodied by a GUI on the monitor 2. Such GUI may be as in FIG. 4, and is used in the generating of adaptive motion simulation as described herein, by enabling the user of the game to configure motion simulation for a particular game.

A capture device 60 may also be present. The capture device 60 may be or may include a microphone(s) or like sound capture device, and/or have image capturing capacity (e.g., camera, CCD, etc). As a variant, the capture device 60 may be software based, and capture for example the digital signal representative of the sound and/or image (e.g., soundtrack channel). For example, the capture device 60 may be an application programming interface in the game engine (e.g., operating system), a functionality integrated into the sound card or video card of the game engine 1 (in any of the above-described formats), a dedicated drive and/or an analysis feature associated with the memory of the game engine 1, or any combination thereof, as examples. The capture device 60 may have an optical capture device that captures images and can produce a signature based on the color content of an image displayed on the screen TV. The microphone may be any appropriate type of sound capture device that captures ambient sound, including audio output from loudspeakers and/or the monitor 2. In some embodiments, the capture device 60 can be made integral to the haptic engine 30. Additionally or alternatively, the capture device 60 can be a standalone device. The capture device 60 can be positioned besides a viewer seat or anywhere within an environment of the audio-visual setup. In these embodiments, the capture device 60 may have microphone opening(s) facing towards the monitor 2. As an alternative to the capture device 60, the haptic engine 30 may receive the audio track or video track from the gaming engine 1 as a line-in signal, for instance shown as 61 in FIG. 1.

Still referring to FIG. 1, the haptic engine 30 is shown as receiving an input from the game controller 3, for instance in serial connection with the game engine 1. The connection may also be parallel, for instance in the case of a wireless game controller 3. In such a case, the haptic engine 30 has wireless communication capability according to any appropriate technology. Accordingly, the haptic engine 30 receives input from the game controller 3 concurrently with the game engine 1.

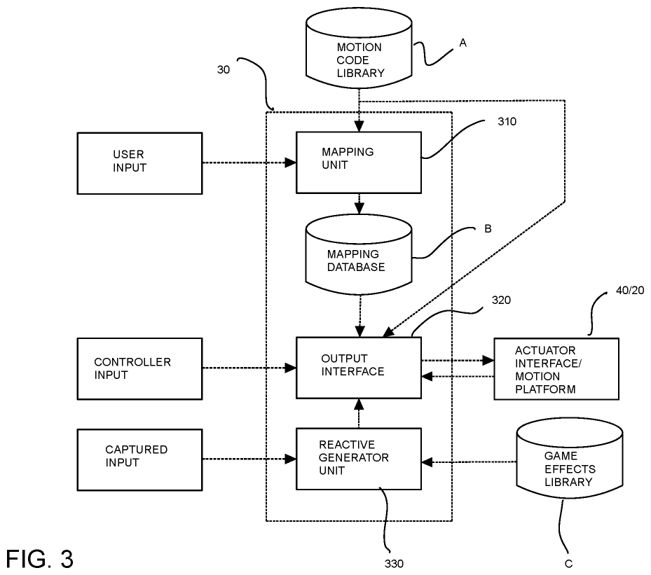

With reference to FIG. 3, an embodiment of the haptic engine 30 is illustrated. The haptic engine 30 can receive various inputs from a user, e.g., via a mouse, game controller 3, keyboard, touchscreen, voice-based input device, and the like. The haptic engine 30 may also receive input from the game controller 3 during a video game, and/or video and/or audio input from the video game, as the video game is played. The haptic engine 30 can access a motion sample library A, a mapping database B and/or a game effects library C. The motion code library A serves as a storage location for motion code (i.e., haptic effect modules), and can store any suitable number of motion samples, for instance in association with tags and/or in a structured file system.

The motion code library A can store different formats of files that will enable the haptic effects to be performed by the system 10, in real-time, during the video output (e.g., the video game). In a variant, the motion code may be in the form of motion samples that are pre-calculated and/or predefined. In another variant, the motion code may be in the form of code/instructions that will be used by a haptic synthesizer that is part of the haptic engine 30. The haptic synthesizer may thus execute the motion code in this code format. For example, the code format may include an effect identification (e.g., effect 1), a generator for the effect (e.g., generator 23), a variation thereof (e.g., variation 4), and a level of amplitude (e.g., amplitude of 6). The generator may be described as being a given wave generator (e.g., sine wave, square wave, triangular wave, etc) and/or may combine and/or may modify predetermined waveforms. Thus, as an alternative to or in addition to the predefined motion samples, the motion code library A may be in the form of dynamic effects in code instructions. In contrast to the predefined motion samples, the dynamic effects in code instructions may provide a greater diversity of effects versus storage capacity. It is also possible to use such code instructions to provide random dynamic effects as a function of any given action.

The mapping database B stores information relating motion code to given inputs of the game controller 3 in pairings, and may also store parameters associated with the motion code to vary the haptic effects, user profiles, all of which may be programmed by users. The mapping database B may have various forms, such as a relational database (SQL variants), files of different formats (e.g., JSON, XML, etc), persistent memory, as examples among others. The game effects library C stores information related to the audio and/or video outputs of any particular video game, such as sounds or images made as reactions to controller inputs (e.g., sounds or colors associated with an explosion). The game effects library C may also include correlations between such sounds or images and game controller inputs, e.g., an explosion occurs as a result of a given controller input. In a variant, the motion code library A, the mapping database B and/or the game effects library C are one and the same. In a variant, the motion code library A and/or the game effects library C are shared libraries (e.g., for access to different users), while the mapping database B may be tied to a given haptic engine 30, or to a user account. The motion code library A, the mapping database B and/or the game effects library C may be part of the haptic engine 30, or may be separated (e.g., cloud based).

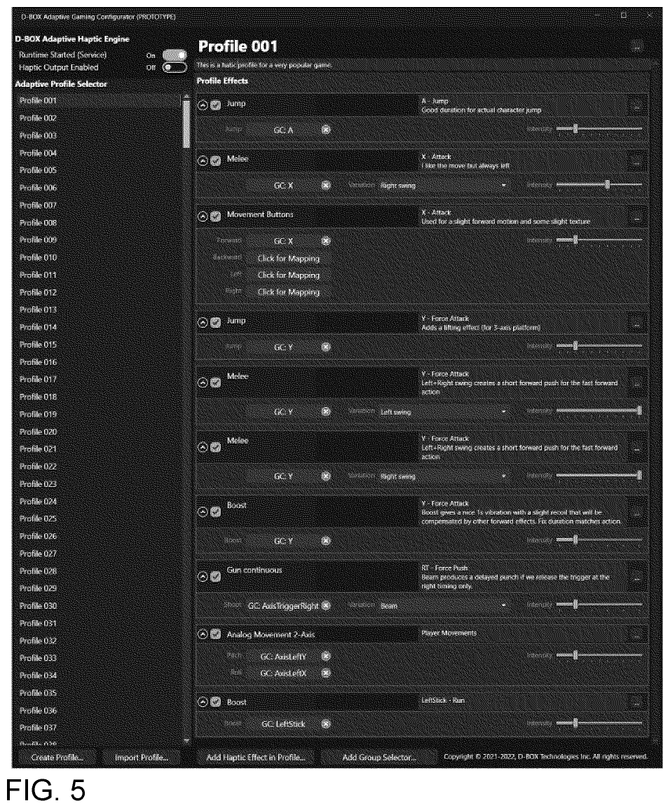

The haptic engine 30 may include a mapping unit 310. The mapping unit 310 is tasked with producing the GUI (e.g., FIG. 5) by which the user may program adaptive motion simulation. The mapping unit 310 is configured for accessing motion code library A, for instance as a response to user inputs. For example, user input can be received via a mouse, game controller 3, keyboard, touchscreen, voice-based input device, and the like, with the GUI of FIG. 5 available to facilitate the configuring. The mapping unit 310 may then be tasked with pairing motion code with given inputs from game controller 3. For instance, as shown in FIG. 2, an exemplary A button on the game controller 3 may be associated with a “jumping” action for in a video game. The input from the game controller 3 may also be a dual input, i.e, A button to jump and left-press on the direction interface or pad, and may result in a single haptic effect, or a composite haptic effect (i.e., layering). Moreover, the input may be from more game controller 3 (e.g., foot pedal, keyboard, used simultaneously). The input from the A button may consequently be paired with a motion sample that generates an upward-downward haptic effect, at the motion platform 20. Such a pairing may then be stored in the mapping database B, such that when button A is activated on the game controller 3 during a video game, the motion platform 20 produces an upward-downward haptic effect, as driven by output interface 320 that receives the A input and outputs the command (e.g., as motion signals) after accessing the pairing from the mapping database B. The haptic effect may therefore be produced on the motion platform 20, without accessing the telemetry data from the video game. The mapping unit 310 may also be used to adjust parameters associated with the motion code to vary the haptic effects. The parameters may be stored in the mapping database B for example as a user profile. Hence, the motion simulation may be said to be adaptive, in that the haptic effects may be adjusted as a function of user preferences.

As shown in FIG. 4, a given input from the game controller 3 may be associated with two or more motion codes for two or more different haptic effects, such that the resulting haptic effect produced by the motion platform 20 is a mix of the motion codes associated with the user input on the game controller 3. This may be referred as a layering, by which the user configures the haptic engine 30 to layer two or more effects for a single controller entry. For example, in the mapping unit 310, the user may select two different haptic effects, represented by the plot lines of (A) and (B). The output interface 320 may therefore mix the codes associated with these haptic effects, that may for example result in the plot line of (C). Depending on the number of actuator(s) 22 for the motion platform 20, some of the motion codes may be directed to a common actuator 22, a common axis of movement of the motion platform 20, a common part of vibrating pad (e.g., associated with a given anatomical part of the user). Accordingly, mixing may be done by the haptic engine 30 to add the various motion codes, and produce a composite haptic effect.

In some embodiments, each of the haptic effects is associated with a category, for instance based on one or more tags. Upon receipt of user input, a listing of various haptic effects can be displayed to the user, who can provide further input regarding which haptic effects of the listing should be added to the mapping database B. In other embodiments, each of the haptic effects is categorized and listed in one folder of a tree of nested folders. User input for navigating the tree can be received, and the haptic effects of various folders can be displayed to the user. Further input regarding selected haptic effects to be added to the mapping database B can additionally be received. Still other forms of user input for adding haptic effects to the mapping database B are considered. It should also be noted that user input associates each of the haptic effect with a respective game controller input and/or audio or visual trigger.

In some embodiments, the user input specifies one or more characteristics of and/or modifiers for the haptic effects. The characteristics may include duration, amplitude, acceleration, velocity, orientation and direction (e.g., pitch, roll, up and down, etc). For example, the user input can specify that the haptic effect should last a predetermined period of time, repeat a predetermined number of times, and the like. In another example, the user input can specify that the motion code be modified in a particular way. For instance, the haptic effect can be amplified to accentuate the movement produced by the motion code. In another case, the haptic effect can be attenuated to produce a more gentle movement than would be produced by the unattenuated motion sample. Still other modifications to motion code and haptic effects are considered.

The output interface 320 may therefore retrieve motion code associated with the input in the mapping database B, the motion code being representative of a haptic effect to be performed by the motion platform 20. The output interface 320 may obtain a motion signal corresponding to the motion code(s), and output a motion signal commensurate with the retrieved motion code to the motion platform 20 for the haptic effect to be performed at the motion platform 20 in synchronicity with an action occurring in the video game. The generating of the motion signal may include The haptic effect may consequently be performed without accessing the telemetry data from the video game. In an embodiment, the output interface 320 includes a synthesizer module, e.g., a computer instructions that may be stored non-transitory computer-readable medium and which, when executed by the processing unit, causing the processing unit to generate a motion based on the motion code, the motion signal driving actuators to perform haptic effects. In a variant, the output interface 320 may simply convert the motion code(s) into an appropriate motion signal format. In a variant, the output interface 320 may generate the motion signal based on the parameters of the motion platform 20.

A reactive generator unit 330 may also receive audio and/or video data to command the generation of haptic effects and/or adjust the parameters of the haptic effects, such that the haptic effects felt at the motion platform 20 are commensurate with the audio and/or video data. The audio and/or video data may be captured via the capturing device 60, or may be obtained from the game engine 1. The reactive generator unit 330 may have access to the game effects library C to recognize sounds and/or images specific to the video game. Hence, with the processing of the audio and/or video data, the reactive generator unit 330 may identify that a particular reaction (e.g., explosion) has taken place in the video game. The reactive generator unit 330 may correlate the particular reaction in the video game to a particular type of game controller input. For example, if a controller input is for attacking a machine target (e.g., via the use of a machine gun), a possible reaction may be the explosion of the machine target. The reactive generator unit 330 may process the captured audio and/or video data to identify such a reaction, retrieve motion code file associated with such a reaction, and then send signals to the motion platform 20 to produce a haptic effect matching the motion code (including synthesizing the haptic effect from the motion code). This may include adjusting the intensity of a haptic effect based on the parameters of the capture (e.g., sound level, pixel area, etc). The reactive generator unit 330 is shown as sending the commands to the output interface 320, for the output interface 320 to mix the motion code from the reactive generator unit 330 with that from the mapping database B. However other arrangements are considered. For example, the reaction motion samples may be stored in the mapping database B as well, and the output interface 320 or the reactive generator unit 330 may retrieve an appropriate motion code file upon capturing a reaction in the video game.

Thus, the output interface 320 may perform mixing of motion code, notably when the motion codes are destined to a same actuator 22, for example when the user programs two haptic effects for a single user input on the controller 3 as described above, in layering, or when the output interface 320 enhances a motion code with captured data from the reactive generator unit 330, also layering. When the output interface 320 mixes different motion codes, the output interface 320 must operate within the parameters of the motion platform 20. For instance, the output interface 320 may operate within the safety parameters of the motion platform 20, the signal saturation limits of the actuator interface 40 and/or motion platform 20, velocity and/or acceleration limits, electrical limits, etc and any combination thereof.

The audio processing done by the reactive generator unit 330 may include one or more of voice removal, frequency filtering, spatial filtering, envelope detection, and/or deep neural network for processing or event detection. The signal resulting from the audio processing can be used as a trigger (with a threshold) for a haptic effect module and/or can be used directly as a haptic signal.

The video processing done by the reactive generator unit 330 may include one or more of pixel detection, region intensity or color monitoring, known bitmap detection, optical flow analysis, deep neural network for processing or event detection. The signal resulting from the video processing can be used as a trigger (with a threshold) for a haptic effect module and/or can be used directly as a haptic signal.

As examples of effectors from the reactive generator unit 330, haptic effects based on audio capture in the low frequency range may result in deep haptic vibrations being generated at the motion platform 20. Audio detection can also be used as triggers. For instance, when there is a sudden attack in the audio envelope, a haptic effect is triggered by the reactive generator unit 330 for generation at the motion platform 20. As part of the library C, or by any other arrangement, the haptic engine 30 may associate a haptic effect module to both an input key trigger and audio. For example, when the B button is pressed on the game controller 3 (FIG. 2), the audio capture is enabled and converted to a haptic signal during a given amount of time (e.g., 2 seconds).

Regarding image capture and processing, the reactive generator unit 330 may look for particular triggers in a display. For example, when a pixel in the health bar turns red, a haptic effect may be triggered and generated. As another example, when the optical flow of the video stream creates visual motion, this visual motion is processed and converted to haptic signal, for example by the reactive generator unit 330. For instance, if the visual scene moves to the left, a corresponding haptic signal may be generated at the motion platform 20.

The mapping unit 310 and output interface 320 may be configured to enable/disable a haptic effect or group of effect modules based on another trigger. For example, after the user presses the “1” key on his keyboard, it enables a first group or first effect, which maps a mouse click to a “shotgun” haptic effect. But after the user presses the “2” key, it enables a second group or second effect instead, which maps the same mouse click to a “flame thrower” haptic effect instead, disabling the first effect in the process. This feature may be referred to as group selector or effect selector, and may including a cooperative action between the mapping unit 310 and the mapping database B or other storage means, to send motion code to the output interface 320 in accordance with the selected effect or group of effect. While the example above refers to a different key or different user command from the game controller 3, the switch function may be as a result of the pressing of the same key repeatedly (e.g., “1” key on keyboard may cause a change of group). The mapping database B or any memory in the haptic engine 30 or elsewhere may keep track of the group or identity of effect that is live, and may have default effect settings. This may also be done by video or audio capture, such as by having the reactive generator unit 330 detect the known “flame thrower” icon in the bottom-right area of the visual display, a group of effect modules is automatically triggered and activated at the motion platform 20.

Hence, the haptic engine 30 generates haptic effects using peripheral information instead of internal gaming telemetry data. The peripheral information may be input from key events and axis movements, from the game controller 3, including the keyboard, mouse, joystick; audio capture and sound processing; video capture and image processing; input from operating system status and processes; user configurations, to feed mappings and context about the game.

The haptic engine 30 may consequently process the various types of inputs and signals in accordance with the user configuration as set using the mapping unit 310, and as stored as in the mapping database B as key mappings (or pairings), intensity settings, context parameters, etc. The haptic engine 30 may generate corresponding haptic signals using digital signal processing modules that may be integrated therein and/or that may be part of the actuator interface 40 or may be in a cloud computing setup, such as filters, signal generators, conditional logic, deep learning decisional networks, etc.

The haptic engine 30 adapts and mixes these haptic signals for the motion platform 20 or like haptic rendering device. The haptic engine 30 may optimize the experience according to the hardware limitations of the motion platform 20 (simulator, vibro-kinetic actuators, vibro-tactile devices, inertial shakers, etc).

Using the mapping unit 310, the user can create many profiles for different game genres (i.e. racing vs battle), different game titles, or different contexts within a game (i.e. different vehicles, or characters). For clarity, a profile can consist of multiple mappings, with additional configuration parameters and metadata, such as a title, instructions, notes, tags, target game, global intensity, etc. or any combination thereof.

In a variant, a profile may be selected and activated manually by the user from a list of profiles, for instance before or during a video game, using the game controller 3, the user interface 60, or any other interface command. The activation may be automatic, for instance after audio or image processing by the audio/image processing unit 330. Likewise, some profiles may be configured to activate automatically when a specific process name/id is detected by the operating system-such as when a game is launched-and stopped automatically when no longer detected-such as when a game is terminated.

A graphical user interface (GUI) (see FIG. 5) may allow the user to create the mapping by pairing inputs with motion samples, though default settings may also be present. With the GUI, the user may browse and search through the list of profiles; activate a profile for real-time processing by the haptic engine 30; view, edit and delete a profile, in a profile editor section; create a new profile; import or export profiles for exchange with other users. In a variant, these import or export profiles may be stored in the mapping database B or elsewhere, for local activation. In a variant, a database (e.g., cloud) may be used to store numerous profiles of numerous participants, and hence enable profile sharing. Thus, a new user may select a configured user profile from such a shared database, so as to be in condition to play a video game rapidly, i.e., without having to configure a personal profile. A rating system may be provided, for the favorite user profiles to be put forward. Once the user selects a user profile, such user profile may be automatically saved locally for use and execution.

As part of the GUI, the profile editor may allow the user to configure various haptic effect modules with many features. For example, haptic effect modules may be added to the profile to allow a user to customize its parameters (input triggers, variations, intensity). Depending on the nature of the video game, various effect modules are available to the user, examples of which include: Single shot haptic effects, activated on a key press or release; Continuous haptic effects, activated while a key is pressed; Haptic effects generated from digital signal processing of an axis value, using signals of inertial sensors as part of the game controller inputs; Haptic effects from sound processing of audio capture using the reactive generator unit 330; Haptic effects from image processing of video capture using the reactive generator unit 330; and Group selector modules.

As further actions possible via the profile editor, using the mapping unit 310 and/or the reactive generator unit 330, the user may associate input key triggers (keyboard, joystick or mouse buttons) to haptic effect modules. For example, a user may add the “gun shot” module from the motion code library A, and associate the A button of the game controller 3 (FIG. 2) to its input. The user will then experience a haptic impulse and recoil effect every time the A button is pressed, via the motion simulator 20.

As other examples of mapping/configuring, the user may associate input axis values (joystick, gamepad analog stick, steering wheel, rudder, pedals) to haptic effect modules, i.e., adding the “axis movement” module and associating the gamepad X axis to its left-right input. The user may for example experience a left-right haptic movement proportional to the activation of the X axis on the game controller 3 (FIG. 2). As another example, a delay logic may be implemented: e.g., When the user presses the “G” key on the game controller 3, it starts a timer which triggers the “grenade explosion” haptic effects when elapsed (e.g., 2 seconds).

The methods and systems for generating adaptive motion samples substantially synchronous with a video game described herein may be implemented in a high-level procedural or object-oriented programming or scripting language, or a combination thereof, to communicate with or assist in the operation of a computer system, for example the haptic engine 30. Alternatively, the methods and systems described herein may be implemented in assembly or machine language. The language may be a compiled or interpreted language. Program code for implementing the methods and systems described herein may be stored on a storage media or a device, for example a ROM, a magnetic disk, an optical disc, a flash drive, or any other suitable storage media or device. The program code may be readable by a general or special-purpose programmable computer for configuring and operating the computer when the storage media or device is read by the computer to perform the procedures described herein. Embodiments of the methods and systems described herein may also be considered to be implemented by way of a non-transitory computer-readable storage medium having a computer program stored thereon. The computer program may comprise computer-readable instructions which cause a computer, or more specifically the at least one processing unit 31 of the haptic engine 30, to operate in a specific and predefined manner to perform the functions described herein.

In some embodiments, each of the motion samples is associated with a category, for instance based on one or more tags. Upon receipt of user input, a listing of various motion samples can be displayed to the user, who can provide further input regarding which motion samples of the listing should be added to the mapping database B. In other embodiments, each of the motion samples is categorized and listed in one folder of a tree of nested folders. User input for navigating the tree can be received, and the motion samples of various folders can be displayed to the user. Further input regarding selected motion samples to be added to the mapping database B can additionally be received. Still other forms of user input for adding motion samples to the mapping database B are considered. It should also be noted that user input associates each of the motion sample with a respective game controller input and/or audio or visual trigger.

In some embodiments, the user input specifies one or more characteristics of and/or modifiers for the motion samples. The characteristics may include duration, amplitude, acceleration, velocity, orientation and direction (e.g., pitch, roll, up and down, etc). For example, the user input can specify that the motion sample should last a predetermined period of time, repeat a predetermined number of times, and the like. In another example, the user input can specify that the motion sample be modified in a particular way. For instance, the motion sample can be amplified to accentuate the movement produced by the motion sample. In another case, the motion sample can be attenuated to produce a more gentle movement than would be produced by the unattenuated motion sample. Still other modifications to motion samples are considered.

Computer-executable instructions may be in many forms, including program modules, executed by one or more computers or other devices. Generally, program modules include routines, programs, objects, components, data structures, etc., that perform particular tasks or implement particular abstract data types. Typically the functionality of the program modules may be combined or distributed as desired in various embodiments.

The system 10 may generally be described as being for generating motion simulation in gaming, and may or may not include a motion platform or like haptic rendering device; a haptic engine including a processing unit and a non-transitory computer-readable medium having stored thereon computer instructions which, when executed by the processing unit, cause the processing unit to implement: receiving an input from a game controller, the input from the game controller configured to cause an action in a video game; in response to a receipt of the input, retrieving a motion sample associated with the input in a database, the motion sample being representative of a haptic effect to be performed by a motion platform; and outputting the retrieved motion sample to the motion platform for the haptic effect to be performed at the motion platform in synchronicity with the action occurring in the video game.

In another variant, the system 10 may be described as including a haptic engine including a processing unit and a non-transitory computer-readable medium having stored thereon computer instructions which, when executed by the processing unit, cause the processing unit to implement: receiving an input from a game controller, the input from the game controller configured to cause an action in a video game; in response to a receipt of the input, retrieving at least one motion code associated with the input in a database, the motion code being representative of a haptic effect to be performed by a motion platform; and obtaining a motion signal corresponding to the at least one motion code and outputting the motion signal to the motion platform for the haptic effect to be performed at the motion platform in synchronicity with the action occurring in the video game.

The system 10 may be receiving, during configuration of the system 10, a user input indicative of at least one haptic effect to be paired with a given input from the game controller, and storing at least one motion code corresponding to the received haptic effect in the database for the retrieving; receiving a user input indicative of at least one parameter of the haptic effect to be paired with the given input, and storing the at least one parameter in the database for the retrieving. Receiving the user input may include receiving two or more of the haptic effects to be paired with a single one of the given input from the game controller in the pairing, and storing two or more of the at least one motion code corresponding to the received haptic effects in the database for the retrieving. Obtaining the motion signal may include mixing the two or more of the at least one motion code associated with the single one of the given input. The storing may be under a user profile. The storing may include storing a plurality of the motion codes in the database, each in association with a respective given input. The system 10 may operate a graphical user interface receiving the user inputs indicative of the at least one haptic effect. Obtaining the motion signal may include synthesizing the motion signal from instructions corresponding to the motion code. Synthesizing the motion signal includes producing a waveform corresponding to the haptic effect, such as based on a selected generator. Synthesizing the motion signal includes providing an amplitude and frequency of the waveform. The system 10 may also be used to capture video and/or audio data from the video game, and process the video and/or audio data; and to obtain a motion signal (e.g., separate from that of the pairing with the given input) as a function of the processing, and outputting the motion signal to the motion platform for a haptic effect to be performed at the motion platform in response to the processing. Obtaining the motion signal as a function of the processing may include mixing the motion signal of the processing with the motion signal corresponding to the response to the receipt of the input. The at least one motion code may include an array of motion samples with a sample rate. Retrieving the at least one motion code associated with the input in the database may include identifying the input as a group selector entry. Identifying the input as the group selector entry may include disabling a current motion code associated with the input, and enabling a subsequent motion code associated with the input, the current motion code and the subsequent motion code different from another. Generating the motion signal may include obtaining the motion signal corresponding to the subsequent motion code. The current motion code may be a default motion code, or a motion code identified at configuration. The subsequent motion code may be stored as current motion code.

A method for generating motion simulation in gaming in accordance with the present disclosure may include receiving an input from a game controller, the input from the game controller configured to cause an action in a video game; in response to a receipt of the input, retrieving a motion sample associated with the input in a database, the motion sample being representative of a haptic effect to be performed by a motion platform; and outputting the retrieved motion sample to the motion platform for the haptic effect to be performed at the motion platform in synchronicity with the action occurring in the video game. While the methods and systems described herein have been described and shown with reference to particular steps performed in a particular order, it will be understood that these steps may be combined, subdivided or reordered to form an equivalent method without departing from the teachings of the present invention. Accordingly, the order and grouping of the steps is not a limitation of the present disclosure.

Various aspects of the methods and systems disclosed herein, may be used alone, in combination, or in a variety of arrangements not specifically discussed in the embodiments described in the foregoing and is therefore not limited in its application to the details and arrangement of components set forth in the foregoing description or illustrated in the drawings. For example, aspects described in one embodiment may be combined in any manner with aspects described in other embodiments. Although particular embodiments have been shown and described, it will be obvious to those skilled in the art that changes and modifications may be made without departing from this invention in its broader aspects. The scope of the following claims should not be limited by the preferred embodiments set forth in the examples, but should be given the broadest reasonable interpretation consistent with the description as a whole.

1. A system for generating motion simulation in gaming comprising:
a haptic engine including a processing unit and a non-transitory computer-readable medium having stored thereon computer instructions which, when executed by the processing unit, cause the processing unit to implement:
receiving an input from a game controller, the input from the game controller configured to cause an action in a video game;
in response to a receipt of the input, retrieving at least one motion code associated with the input in a database, the motion code being representative of a haptic effect to be performed by a motion platform; and
obtaining a motion signal corresponding to the at least one motion code and outputting the motion signal to the motion platform for the haptic effect to be performed at the motion platform in synchronicity with the action occurring in the video game.

2. The system according to claim 1, including receiving a user input indicative of at least one haptic effect to be paired with a given input from the game controller, and storing at least one motion code corresponding to the received haptic effect in the database for the retrieving.

3. The system according to claim 2, including receiving a user input indicative of at least one parameter of the haptic effect to be paired with the given input, and storing the at least one parameter in the database for the retrieving.

4. The system according to claim 2, wherein receiving the user input includes receiving two or more of the haptic effects to be paired with a single one of the given input from the game controller in the pairing, and storing two or more of the at least one motion code corresponding to the received haptic effects in the database for the retrieving.

5. The system according to claim 4, wherein obtaining the motion signal includes mixing the two or more of the at least one motion code associated with the single one of the given input.

6. The system according to claim 2, wherein the storing is under a user profile.

7. The system according to claim 2, wherein the storing includes storing a plurality of the motion codes in the database, each in association with a respective given input.

8. The system according to claim 2, including operating a graphical user interface receiving the user inputs indicative of the at least one haptic effect.

9. The system according to claim 1, including a motion platform for performing the haptic effect in synchronicity with the action occurring in the video game.

10. The system according to claim 1, wherein obtaining the motion signal includes synthesizing the motion signal from instructions corresponding to the motion code.

11. The system according to claim 10, wherein synthesizing the motion signal includes producing a waveform corresponding to the haptic effect.

12. The system according to claim 11, wherein synthesizing the motion signal includes providing an amplitude and frequency of the waveform.

13. The system according to claim 1, further including:
capturing video and/or audio data from the video game, and
processing the video and/or audio data; and
obtaining a motion signal as a function of the processing, and outputting the motion signal to the motion platform for a haptic effect to be performed at the motion platform in response to the processing.

14. The system according to claim 13, wherein obtaining the motion signal as a function of the processing includes mixing the motion signal of the processing with the motion signal corresponding to the response to the receipt of the input.

15. The system according to claim 1, wherein the at least one motion code includes an array of motion samples with a sample rate.

16. The system according to claim 1, wherein retrieving the at least one motion code associated with the input in the database includes identifying the input as a group selector entry.

17. The system according to claim 16, wherein identifying the input as the group selector entry includes disabling a current motion code associated with the input, and enabling a subsequent motion code associated with the input.

18. The system according to claim 17, wherein generating the motion signal includes obtaining the motion signal corresponding to the subsequent motion code.

19. The system according to claim 17, wherein the current motion code is a default motion code.

20. The system according to claim 17, further including storing the subsequent motion code as current motion code.
